(19) United States
(12) Patent Application Publication
(10) Pub. No.: US 2016/0109733 A1
(43) Pub. Date: Apr. 21, 2016

(54) ELECTRO-OPTIC PHASE MODULATOR

(71) Applicant: IXBLUE, SAINT-GERMAIN-EN-LAYE (FR)

(72) Inventors: Henri PORTE, SERRE LES SAPINS (FR); Nicolas GROSSARD, AUDEUX (FR)

(21) Appl. No.: 14/882,933

(22) Filed: Oct. 14, 2015

(30) Foreign Application Priority Data
Oct. 15, 2014 (FR) 14 59893

(51) Int. Cl. G02F 1/03; G02F 1/035

(52) U.S. Cl. CPC G02F 1/0316; G02F 1/0356; G02F 1/0353

(57) ABSTRACT

The electro-optic phase modulator, intended to modulate the optical phase of an incident lightwave, includes an electro-optic substrate with an entrance face and an exit face; an optical waveguide extending between a guide entrance end located on the entrance face and a guide exit end located on the exit face, the incident lightwave being partially coupled in the waveguide into a guided lightwave propagating in an optically guided manner along the optical path of the waveguide between the entrance end and the exit end; at least two electrodes arranged at least partially along the waveguide, parallel to and on either side of the latter, defining between each other an inter-electrode gap, which allow to introduce, when a modulation voltage is applied between them, a modulation phase-shift, function of the modulation voltage, on the guided lightwave. The waveguide has one first curved guide portion between the entrance end and the electrodes.

### FIELD OF THE INVENTION

The present invention generally relates to the field of optical modulators for controlling light signals.

It more particularly relates to an electro-optic phase modulator intended to modulate the optical phase of a lightwave incident on the modulator.

### BACKGROUND OF THE INVENTION

An electro-optic phase modulator is an optoelectronic device that allows to modulate the optical phase of a lightwave that is incident on the modulator and that passes through it, as a function of an electric signal that is applied thereto.

A particular category of electro-optic phase modulators is known from the prior art, referred to as integrated modulators or guided optics modulators, which include:
an optically transparent substrate comprising an entrance face, an exit face, two lateral faces, a lower face and an upper face, said lower and upper faces extending between the entrance face and the exit face, said upper face being planar and opposite to said lower face,
an optical waveguide that extends, in a plane parallel to said upper face, between a guide entrance end located on said entrance face of the substrate and a guide exit face located on said exit face of the substrate, said incident lightwave being partially coupled in said optical waveguide into a guided lightwave propagating in an optically guided manner along the optical path of said optical waveguide between said guide entrance end and said guide exit end, and
at least two electrodes that are arranged at least partially along said waveguide, parallel to and on either side of the latter, and that define between each other an inter-electrode gap, said at least two electrodes allowing to introduce, when a modulation voltage is applied between said electrodes, a modulation phase-shift, function of said modulation voltage, on said guided lightwave propagating in said optical waveguide.

In the present application, an electro-optic substrate is meant to be monobloc, that is made from a single piece. In other words, the electro-optic substrate is not a separate part of a more complex optical structure such as a stack comprising said electro-optic substrate, one or more intermediate layers, and a support for the mechanical strength of said structure.

The polarization of the modulation electrodes with the modulation voltage allows, by electro-optic effect in the substrate, to vary the optical refractive index of the waveguide in which the guided lightwave propagates, as a function of this modulation voltage.

This variation of optical refractive index of the waveguide then introduces a modulation phase-shift, phase advance or delay, as a function of the sign of the modulation voltage, on the optical phase of the guided lightwave passing through the waveguide.

This results, at the modulator exit, in an optical phase modulation of the emerging lightwave.

In theory, such an electro-optic phase modulator modulates only the optical phase of the guided lightwave propagating in the optical waveguide. So, if a photo-detector is placed on the trajectory of the emerging lightwave at the exit of this modulator, then the optical power (in Watt) measured by this photo-detector will be constant and independent of the modulation phase-shift introduced in the guided lightwave thanks to the modulation electrodes.

In practice, however, the optical power measured is not constant and a low variation of the optical power is detected at the exit of the phase modulator.

This Residual Amplitude Modulation or “RAM” proves, in some cases, to be non-negligible so that the performances of the phase modulator are damaged.

So as to remedy the above-mentioned drawback of the state of the art, the present invention proposes an electro-optic phase modulator allowing to reduce the residual amplitude modulation at the exit of this modulator.

### SUMMARY OF THE INVENTION

For that purpose, the invention relates to an electro-optic phase modulator as defined in the introduction.

According to the invention, said optical waveguide has at least one first curved guide portion between said entrance end and said at least two electrodes, such that the extension of a direction tangent to said waveguide on said entrance face deviates from said inter-electrode gap.

The device according to the invention hence allows to reduce the coupling between the lightwave guided in the optical waveguide and a lightwave that propagates in a non-optically guided manner in the electro-optic substrate.

Indeed, at the guide entrance end, at the time of injection of the incident lightwave into the optical waveguide, a part of this incident lightwave is not coupled to the waveguide but diffracted at the entrance face, so that a lightwave radiates and then propagates in the substrate in a non-guided manner, out of the waveguide.

This non-guided lightwave has a transverse spatial extension, in a plane that is perpendicular to the waveguide, which, by diffraction, increases up to the exit face of the substrate.

In other words, the light beam associated with the non-guided lightwave has an angular divergence that increases during the propagation of the light beam in the substrate, out of the waveguide.

With no particular precaution, when the electric voltage, referred to as modulation voltage, is applied between the electrodes, it appears that a part of the lightwave propagating in a non-guided manner in the substrate may be trapped then guided in an index modulation area that extends in the substrate from the inter-electrode gap, this index modulation area extending spatially about the optical waveguide in a direction transverse to the latter, over a distance at least equal to the dimension of the electrodes along the waveguide.

Thanks to the first curved guide portion, the inter-electrode gap is offset with respect to the direction tangent to the waveguide on the entrance face that corresponds to the main direction of propagation of the non-guided lightwave in the substrate.

Hence, this configuration allows to avoid that the non-guided lightwave, which propagates in the electro-optic substrate, centred about this tangent direction, is trapped and confined in the inter-electrode gap, then overlaps with the guided lightwave at the guide exit end, so that these two lightwaves interfere with each other, hence giving rise to the mentioned residual amplitude modulation.

Therefore, thanks to the invention, the interferences between the guided lightwave and the non-guided lightwave at the exit of the modulator are considerably reduced.

That way, the residual amplitude modulation is strongly lessen.

Moreover, other advantageous and non-limitative characteristics of the electro-optic phase modulator according to the invention are the following:
said optical waveguide has at least one second curved guide portion between said at least two electrodes and said guide exit end;
said first and/or said second curved guide portion has a S-shape;
said first and/or said second curved guide portion has a radius of curvature R_{C} whose value is higher than a predetermined minimum value R_{C,min}, so that the optical losses induced by each curved portion are lower than 0.5 dB;
said minimum value R_{C,min} of the radius of curvature of each curved guide portion is higher than or equal to 20 mm.

### BRIEF DESCRIPTION OF DRAWINGS

The following description with respect to the appended drawings, given by way of non-limitative examples, will allow to well understand in what consists the invention and how it may be made.

In the appended drawings:

FIG. 1 shows a top view of a first embodiment of an electro-optic phase modulator according to the invention including a pair of modulation electrodes and connected at the entrance and at the exit to a section of optical fibre;

FIG. 2 is a cross-sectional view of the phase modulator of FIG. 1, along a section plane A-A;

FIG. 3 is a projection view of the modulator of FIG. 1 in a projection plane perpendicular to the section plane A-A that comprises the two guide ends;

FIG. 4 shows a top view of a second embodiment of an electro-optic phase modulator according to the invention, including three modulation electrodes;

FIG. 5 shows a schematic view of the operation of the device of FIG. 1, in which are shown the optical modes associated with the guided and non-guided lightwaves;

FIG. 6 shows a top view of a third embodiment of an electro-optic phase modulator according to the invention, including a second curved guide portion and in which are shown the optical modes associated with the guided and non-guided lightwaves;

FIG. 7 shows a top view of a variant of the third embodiment of an electro-optic phase modulator according to the invention, in which the modulator includes two additional pairs of polarization electrodes arranged on either side of the first and second curved guide portions.

### DETAILED DESCRIPTION OF THE INVENTION

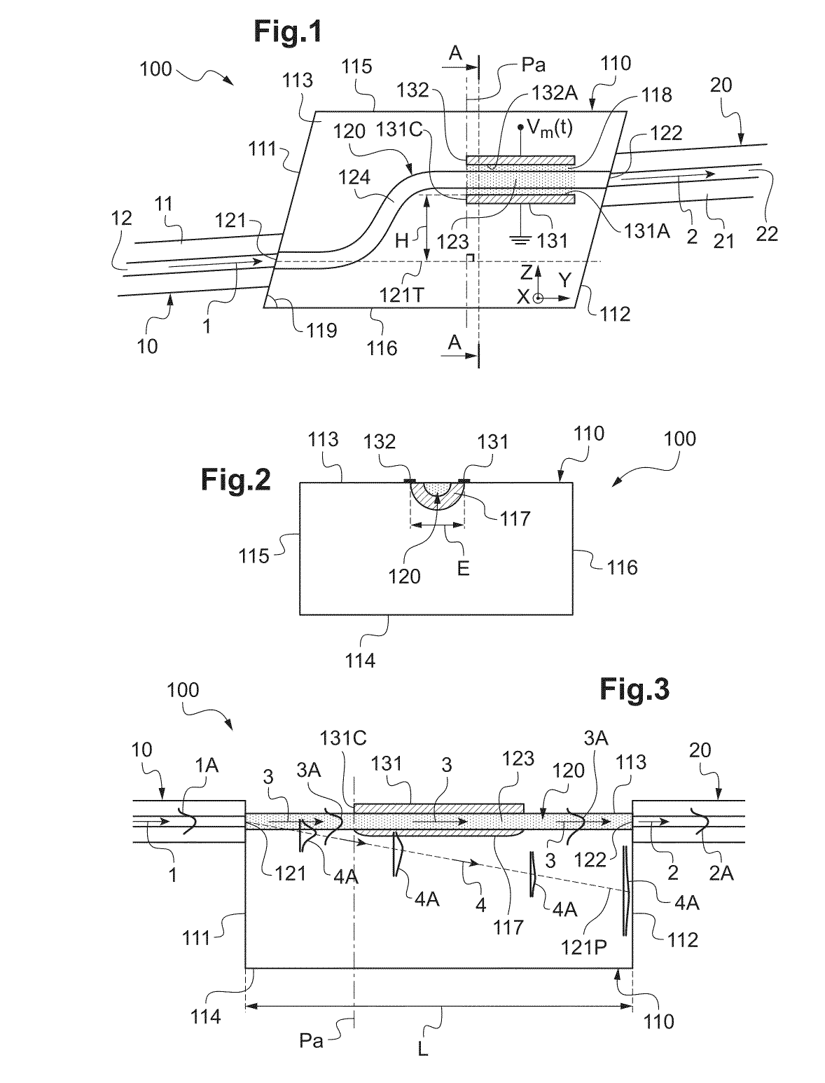

In FIGS. 1 to 7 are shown different embodiments of an electro-optic phase modulator 100, as well as some variants thereof.

Generally, this modulator 100 is intended to modulate, as a function of time, the optical phase of an incident lightwave 1 (herein represented by an arrow, cf. for example FIG. 1) on the modulator 100.

Such a modulator 100 finds many applications in optics, in particular in fibre-optic telecommunications for data transmission, in the interferometric sensors for information processing, or in the dynamic control of laser cavities.

The modulator 100 first comprises an optically-transparent substrate 110.

This substrate 110 comprises, on the one hand, an entrance face 111, and on the other hand, an exit face 112. It has herein a planar geometry with two lateral faces 115, 116, a lower face 114 and an upper face 113 (see FIGS. 1 and 2, for example), the upper face 113 being planar and opposite to the lower face 114.

The lower face 114 and the upper face 113 hence extend between the entrance face 111 and the exit face 112 of the substrate 110, by being parallel to each other.

Likewise, as shown in FIGS. 1 and 2, the entrance face 111 and the exit face 112 are here again parallel to each other, just like the lateral faces 115, 116.

The substrate 110 has hence the shape of a parallelepiped.

Preferably, this parallelepiped is not straight and the substrate 110 is such that the entrance face 111 and one of the lateral faces (here the lateral face 116, see FIG. 1) form an angle 119 lower than 90°, comprised between 80° and 89.9°, for example equal to 85°.

The advantage of such an angle 119 to improve the performances of the phase modulator 100 will be understood in the following of the description. As shown in FIGS. 2 and 3, the substrate 110 is monobloc and formed from a single crystal of lithium niobate.

The substrate 110 has preferably a thickness, from the lower face 114 to the upper face 113, which is strictly greater than 20 microns. Even more preferably, the thickness of the substrate 110 ranges from 30 microns to 1 millimeter.

Moreover, the substrate 110 has a length from the entrance face 111 to the exit face 112, which is comprised between 10 and 100 millimeters.

Preferably, the substrate 110 has a width, measured between the two lateral faces 115, 116, which is comprised between 0.5 and 100 millimeters.

The substrate 110 is an electro-optic substrate that shows a first-order birefringence induced by a static or variable electric field, also called Pockels effect.

This electro-optic substrate 110 is preferably formed of a lithium niobate crystal, of chemical formula LiNbO₃, this material having a strong Pockels effect.

The substrate 110 has moreover an optical refractive index nₛ comprised between 2.25 and 2.13 for a wavelength range comprised between 400 nanometres (nm) and 1600 nm.

As a variant, the electro-optic substrate of the phase modulator may be a lithium tantalum crystal (LiTaO₃).

As another variant, this electro-optic substrate may be made of a polymer material or a semi-conductor material, for example silicon (Si) or gallium arsenide (GaAs).

The substrate 110 of the modulator being herein a lithium niobate crystal, the latter has an intrinsic birefringence, which may be subtracted from or added to a birefringence induced by an electric field, and it is important to precise the geometry and the orientation of this substrate 110 with respect to the axes of this crystal.

In the first and third embodiments of the invention shown in FIGS. 1-3, 5 and 6-7, respectively, the substrate 110 is hence cut along the axis X of the LiNbO₃ crystal, so that the upper face 113 of the substrate 110 is parallel to the plane X-Y of the crystal (see FIG. 1). Still more precisely, the axis Y of the crystal is here oriented parallel to the lateral faces 115, 116 of the electro-optic substrate 110.

By convention, for the lithium niobate, the axis Z is parallel to the axis C or a3 of the crystal lattice. The axis Z is perpendicular to the axis X of the crystal, which is itself parallel to the axis al of the lattice. The axis Y is perpendicular both to the axis Z and to the axis X. The axis Y is turned by 30° with respect to the axis a2 of the lattice, itself oriented at 120° with respect to the axis al and at 90° with respect to the axis a3. The cuts and orientations of the crystal faces generally refer to the axes X, Y and Z.

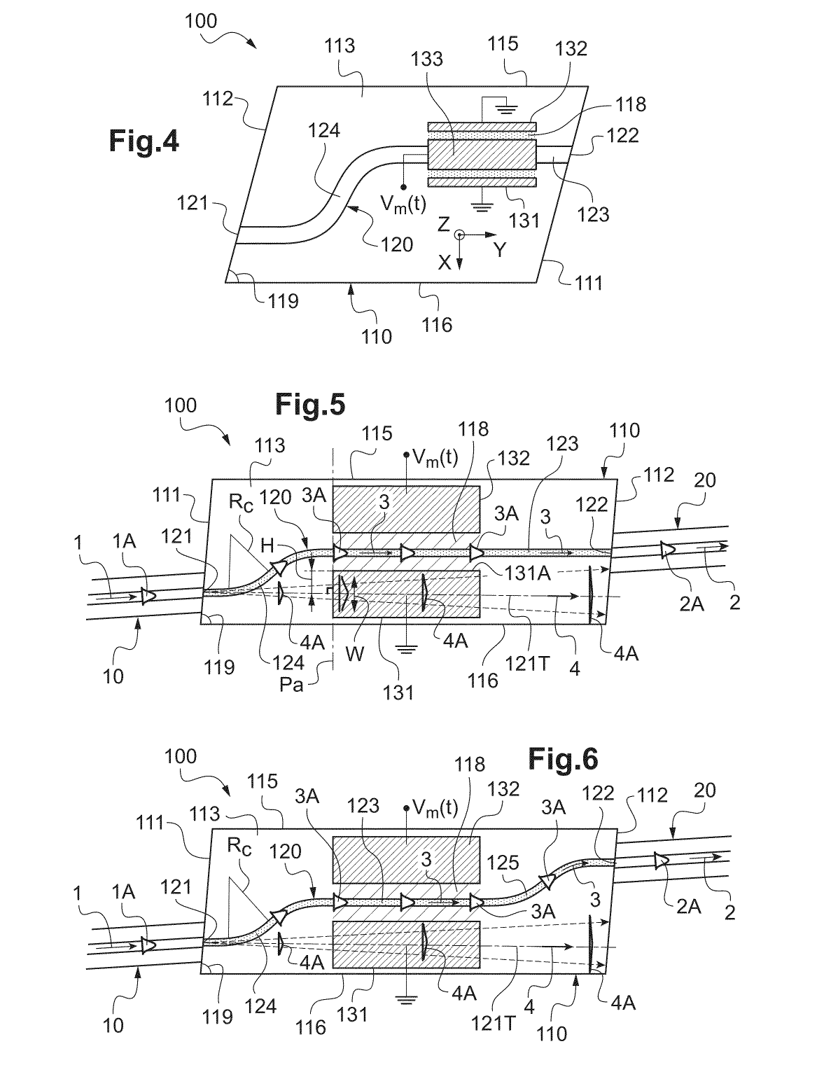

In the second embodiment of the invention shown in FIG. 4, the substrate 110 is cut along the axis Z of the LiNbO₃ crystal, so that the upper face 113 of the substrate 110 is parallel to the plane X-Y of the crystal. Still in this case, the axis Y of the crystal is oriented parallel to the lateral faces 115, 116 of the electro-optic substrate 110.

In all the embodiments, the phase modulator 100 is of the integrated type and comprises a unique optical waveguide 120 that extends continuously (see FIG. 1 and FIGS. 3 to 8):
from a guide entrance end 121 located on the entrance face 111 of the substrate 110,
to a guide exit end 122 located on the exit face 112 of the substrate 110.

In the planar configuration described, the waveguide 120 extends in a parallel plane that is close to the upper surface 113 of the substrate 110.

In particular herein, as shown for example in FIGS. 2 and 3 for the first embodiment, the waveguide 120 flushes with the upper face 113 of the substrate 110 and has a semi-circular cross-section (see FIG. 2) of radius of 3-8 micrometres according to the aimed working wavelength.

Preferably, the optical waveguide 120 has a length which is comprised between 10 and 100 millimeters.

This waveguide 120 may be made in the lithium niobate substrate 110 by a thermal process of diffusion of the titanium in the lithium niobate crystal of the substrate or by an annealed proton-exchange process, well known by the one skilled in the art.

That way, an optical waveguide 120 is obtained, which shows an increase of optical refractive index Δn_{g}. If the method of manufacturing of the optical waveguide is the diffusion of titanium, the two refractive indices, ordinary and extra-ordinary, see their value increase. The guide made by diffusion of titanium may then support the two states of polarization. If the method of manufacturing the optical waveguide is the proton exchange, in this case, only the extraordinary refractive index sees its value increase, whereas the ordinary refractive index sees its value decrease. The waveguide made by proton exchange can hence support only one state of polarization.

In order to ensure the guidance of the light, this optical refractive index n_{g} of the waveguide 120 must be higher than the optical refractive index nₛ of the substrate 110.

Generally, the higher the difference n_{g}−nₛ of optical refractive index between the waveguide 120 and said electro-optic substrate 110, the higher the confinement of the light.

Advantageously herein, the difference n_{g}−nₛ of optical refractive index between the waveguide 120 and said electro-optic substrate 110 is comprised in a range from 10⁻² to 10⁻³.

In order to modulate the incident lightwave 1, the optical phase modulator 100 also includes modulation means.

In the first and third embodiments of the invention shown in FIGS. 1-3, 5 and 6-7, respectively, where the substrate 110 is cut along the axis X, these modulation means include two modulation electrodes 131, 132 arranged at least partially along the waveguide 120, parallel to and on either side of the latter.

In the different embodiments, these modulation electrodes 131, 132 are more precisely arranged around a rectilinear portion 123 of the waveguide 120.

Moreover, as shown in FIG. 1, the two modulation electrodes 131, 132 each comprise an inner edge 131A, 132A turned towards the waveguide 120. They hence define between each other an inter-electrode gap 118 that extends from the inner edge 131A of the first modulation electrode to the inner edge 132A of the second modulation electrode 132.

The two modulation electrodes 131, 132 are spaced apart by a distance E (see FIG. 2) higher than the width of the waveguide 120 at the upper face 113 of the substrate 110, so that the modulation electrodes 131, 132 do not overlap the waveguide 120. The inter-electrode distance E, delimited by the two inner edges 131A, 132A of the modulation electrodes 131, 132, hence corresponds to the transverse dimension, or width, of the inter-electrode gap 118.

For example, the waveguide 120 has herein a width of 3 microns and the inter-electrode distance E is equal to 10 microns.

In the second embodiment of the invention shown in FIG. 4, where the substrate 110 is cut according to the axis Z, the modulation means include three modulation electrodes 131, 132, 133 arranged parallel to said waveguide 120.

The first electrode, or central electrode 133, which has a higher width than that of the waveguide 120, is located above the latter.

The second and third electrodes, or lateral counter-electrodes 131, 132, are for their part located on either side of the waveguide 120, each spaced apart by a distance E′ with respect to the central electrode 133, this distance E′ being determined between the centre of the lateral counter-electrodes 131, 132 and the centre of the central electrode 133.

For example, the waveguide 120 having here a width of 3 microns and the distance E′ between the central electrode 133 and the counter-electrodes 131, 132 is equal to 10 microns.

In the same way as above for the first embodiment, the two modulation electrodes 131, 132 define between each other an inter-electrode gap 118 (see FIG. 4), that extends between the two counter-electrodes 131, 132, from the inner edge of the second electrode 131 to the inner edge of the third electrode 132.

Conventionally, the modulation electrodes 131, 132, 133 are coplanar and formed on the upper face 133 of the substrate 110 by known techniques of photo-lithography.

The dimensions (width, length, and thickness) of the modulation electrodes 131, 132, 133 are determined as a function of the phase modulation constraints of the modulator, of the nature and the geometry of the substrate 110 (dimensions and orientation), of the width and length of the waveguide 120, and of the performances to be reached.

The modulation electrodes 131, 132, 133 are intended to be polarized by a modulation voltage, herein noted Vₘ(t), the modulation voltage being a voltage varying as a function of time t.

In other words, this modulation voltage Vₘ(t) is applied between the modulation electrodes 131, 132, 133.

For that purpose, one of the modulation electrodes is brought to an electric potential equal to the modulation voltage Vₘ(t) (electrode 132 in the case of the first and third embodiments, see FIGS. 1 and 6 for example; electrode 133 in the case of the second embodiment, see FIG. 4), whereas the other modulation electrode (electrode 131, cf. FIGS. 1 and 6 for example) or electrodes (electrodes 131, 132, cf. FIG. 4) are connected to the ground. Electric control means (not shown) are provided, which allow to apply to said modulation electrodes 131, 132, 133 the desired set-point (amplitude, frequency . . . ) for the modulation voltage Vₘ(t).

In order to understand the advantages of the invention, the operation of the electro-optic phase modulation 100 will be first briefly described.

The phase modulator 100 is designed to (see FIG. 3):
receive at the entrance the incident lightwave 1 to couple it into a guided lightwave 3,
modulate the optical phase of this guided lightwave 3 propagating in the waveguide 120, and
couple the guided lightwave 3 into an emerging lightwave 2 delivered at the exit of the modulator 100, the optical phase of this emerging lightwave 2 having a modulation similar to that of the guided lightwave 3.

In order to couple at the entrance, and respectively at the exit, the incident lightwave 1, respectively the emerging lightwave 2, the modulator 100 includes means for coupling the incident lightwave 1 at the guide entrance end 121 and means for coupling the emerging lightwave 2 at the guide exit end 122.

These coupling means herein comprise preferably sections 10, 20 of optical fibre (see FIG. 3), for example a silica optical fibre, each comprising a cladding 11, 21 surrounding a core 12, 22 of cylindrical shape in which propagate the incident lightwave 1 (in the core 12) and the emerging lightwave 2 (in the core 22), respectively, each hence having a symmetry of revolution.

By way of example, the amplitude 1A of the incident lightwave 1 propagating in the core 12 of the section 10 of optical fibre and the amplitude 2A of the emerging lightwave 2A propagating in the core 22 of the section 20 of optical fibre are shown in FIG. 3. These amplitudes 1A, 2A correspond to propagation modes in the sections 10, 20 of optical fibre that have a cylindrical symmetry.

In order to perform the coupling, the sections 10, 20 of optical fibre are brought close to the entrance face 111 and the exit face 112, respectively, so that the core 12, 22 of each section 10, 20 of optical fibre is aligned opposite the guide entrance end 121 and the guide exit end 122, respectively.

Advantageously, it can be provided to use an index-matching glue between the sections 10, 20 of optical fibre and the entrance 111 and exit 112 faces of the substrate 110 in order, on the one hand, to fix said sections 10, 20 of optical fibre to the substrate 110, and on the other hand, to freeze the optical and mechanical alignment between the core 12, 22 of the fibre 10, 20 with respect to the entrance 121 and exit 122 ends of the waveguide 120.

At the entrance, the incident lightwave 1 that propagates along the core 12 of the section 10 of optical fibre towards the substrate 110 is partially coupled in the optical waveguide 120 at the guide entrance end 121 as the guided lightwave 3 (see arrows in FIG. 3).

This guided lightwave 3 then propagates in an optically guided manner, along the optical path of the optical waveguide 120 between the guide entrance end 121 and exit end 122.

The guided lightwave 3 has an amplitude 3A such as schematically shown in FIG. 5.

Due to the partial reflections of the guided lightwave 3 on the entrance face 111 and the exit face 112, interferences may be created in the waveguide 120 so that the amplitude 3A of the guided lightwave 3 can have a relatively high residual amplitude modulation.

Nevertheless, thanks to the angle 119 of the substrate 110, this phenomenon of interferences is highly reduced so that the residual amplitude modulation due to these spurious reflections become negligible.

When the electric control means apply the modulation voltage Vₘ(t) between the modulation electrodes 131, 132, 133, an external electric field, proportional to this modulation voltage Vₘ(t), is created in the vicinity of the modulation electrodes 131, 132, 133, more precisely in an index modulation area 117 (see FIGS. 2 and 3 for example) corresponding to the region of the substrate 110 and of the waveguide 120 located in the inter-electrode gap 118.

This index modulation area 117 extends in the substrate 110 from the inter-electrode gap 118. More precisely, the index modulation area 117 extends spatially about the waveguide 120, herein the rectilinear portion 123 thereof, in a direction transverse to the latter, over a distance at least equal to the dimension (i.e. the length) of the electrodes along the waveguide 120.

By Pockels effect, the optical refractive index n_{g} of the waveguide is modified by this external electric field. As known, the variation of the optical refractive index is proportional to the amplitude of the external electric field, the coefficient of proportionality depending both on the nature of the material and on the geometry of the modulation electrodes 131, 132, 133.

Moreover, as a function of the orientation of the external electric field with respect to the optical axes of the substrate 110, this variation in the vicinity of the modulation electrodes 131, 132, 133 may be positive or negative, with an increase or a decrease, respectively, of the optical refractive indices nₛ, n_{g} of the substrate 110 and of the waveguide 120 in the index modulation area 117.

During the propagation of the guided lightwave 3 in the waveguide 120, this variation of the optical refractive index n_{g} of the waveguide 120 introduces in the optical phase of the guided lightwave 3 propagating in the optical waveguide 120, a modulation phase-shift, that is function of the amplitude of the external electric field and hence of the amplitude of the modulation voltage Vₘ(t) that varies as a function of time t.

As a function of the sign of the modulation voltage Vₘ(t), and hence of the orientation of the external electric field with respect to the optical axes of the substrate 110, this modulation phase-shift may be positive or negative, associated with an optical phase delay or advance, respectively, of the guided lightwave 3.

That way, thanks to the modulation electrodes 131, 132, 133, the optical phase of the guided lightwave 3 may be modulated.

Let's now come back to the coupling of the incident lightwave 1 in the optical waveguide 120.

During this coupling, due to the difference of refractive index spatial distribution between the core 12 of the section 10 of optical fibre and the waveguide 120 in the substrate 110, a part of the incident lightwave 1 is diffracted at the guide entrance end 121, so that a non-guided lightwave 4 in the waveguide 120 propagates in the substrate 110 (see FIG. 3).

This non-guided lightwave 4 can, if it passes through the index modulation area 117, be guided and confined in this index modulation area 117 so that this non-guided lightwave 4 does no longer diffracts and diverges in the index modulation area 117, so that it is able to be recoupled with the guided lightwave 3 in the section 20 of the exit optical fibre.

This non-guided lightwave 4, whose amplitude 4A is shown in FIG. 3, may interfere at the guide exit end 122 with the guided lightwave 3 in the waveguide 120, hence creating a residual amplitude modulation in the emerging lightwave 2 at the exit of the modulator 100.

According to the invention, in order to prevent these interferences and to limit the residual amplitude modulation, the optical waveguide 120 of the modulator 100 is non-rectilinear and has a first curved guide portion 124 (see FIGS. 1, and 4 to 7) between the guide entrance end 121 and the modulation electrodes 131, 132, 133.

This first curved guide portion 124 has a shape and dimensions selected so as to laterally offset the inter-electrode gap 118 with respect to the direction of propagation of the non-guided lightwave 4.

More precisely, according to the invention, the first guide curved portion 124 is such that the extension of a direction 121T tangent to the waveguide 120 on the entrance face 111 deviate from the inter-electrode gap 118.

In other words, it is advisable, in order to avoid the trapping of the non-guided lightwave 4 in the index modulation area 117, that the refraction plane, associated with the incident lightwave 1 at the entrance of the waveguide 120 and containing in particular the tangent direction 121T, does not intercept the inter-electrode gap 118.

The direction 121T tangent to the waveguide 120 on the entrance face 121 corresponds conventionally to the main direction of refraction of the incident lightwave 1 in the waveguide 120, or more precisely herein to the projection of this main direction on one of the upper 113 or lower 114 faces.

In other words, this tangent direction 121T corresponds to the main direction of propagation of the guided lightwave 2 in the waveguide 120 at the guide entrance end 121. Nevertheless, after being entered into the waveguide 120, the guided lightwave 3 follows the optical path of the waveguide 120 so that it arrives on the exit face 112 at the guide exit end 122.

Likewise, the non-guided lightwave 4 propagates freely in the substrate 110 from the guide entrance end 121 up to the exit face 112 of the substrate 110, with a main direction of propagation 121P (see FIG. 3) coplanar with the tangent direction 121T in the refraction plane.

Hence, from FIG. 5, it is understood that, thanks to the first curved guide portion 124, the non-guided lightwave 4 does no longer pass through the index modulation area 117 that extends in the substrate 110 from the inter-electrode gap 118, so that the non-guided lightwave 4 is no longer guided in the substrate 110, under the modulation electrodes 131, 132.

The non-guided lightwave 4 then propagates in the substrate 110 along the trajectory shown in FIG. 3, even during the application of a modulation voltage Vₘ(t) between the modulation electrodes 131, 132.

Moreover, as also shown in FIG. 5, the non-guided lightwave 4 diverges and shows an amplitude 4A that, by diffraction, spreads as the propagation goes along, so that the non-guided lightwave overlaps only partially with the guided lightwave 3 at the guide exit end 122, with the result that they cannot interfere as much between each other and lead to a residual amplitude modulation in the emerging lightwave 2 at the exit of the modulator 100.

As shown in FIGS. 1 and 5, the first curved guide portion 124 introduces a gap, denoted H in the following of the description, between the non-guided lightwave 4 and the inter-electrode gap 118.

More precisely, this gap H corresponds (see FIG. 1 for example) to the distance between the tangent direction 121T and the inner edge 131A of the first electrode 131 that is located between the optical waveguide 120 and the tangent direction 121T.

In other words, the gap H is herein equal to the distance between:
the plane comprising the tangent direction 121T and orthogonal to the upper face 113 of the substrate 110, and
the plane tangent to the inner edge 131A and orthogonal to the upper face 113 of the substrate 110.

This gap H is measured in a front plane Pₐ (cf. FIG. 1) that is, on the one hand, perpendicular to the tangent direction 121T, and on the other hand, comprising a front edge 131 C of the first electrode 131.

Advantageously, the shape and dimensions of the first curved guide portion 124 are determined so that the gap H introduced by this first curved guide portion 124 is higher than a predetermined threshold value Hₘᵢₙ.

That way, the non-guided lightwave 4 remains remote from the inter-electrode gap 118 so that the non-guided lightwave 4 cannot be trapped by the index modulation area 117.

The non-guided lightwave being diffracted in the substrate 110, it has an amplitude 4A (see FIG. 3), whose extent, or spatial extension w (see FIG. 5) in the above-defined front plane Pₐ, increases during the propagation between the entrance face 111 and the exit face 112.

In order to avoid the trapping by the index modulation area 117, the threshold value Hₘᵢₙ is predetermined as a function of, w representing the spatial extension w of the non-guided lightwave 4.

Preferably, the threshold value Hmin is determined as being higher than or equal to w/2, that is to half the spatial extension w, so that only a very small part of the non-guided lightwave 4 may still travel through the index modulation area 117, in the vicinity of the inter-electrode gap 118.

More preferably, in order to take into account the width E of the inter-electrode gap 118 (cf. FIG. 2), the predetermined threshold value Hₘᵢₙ is predetermined as being equal to w/2+E.

The first curved guide portion 124 has herein a S-shape (see FIG. 5) with two opposite curvatures each having a radius of curvature R_{C} (see FIG. 5), whose value is higher than a predetermined minimum value R_{C,min} so that the optical losses induced by this first curved guide portion 124 are lower than 0.5 dB.

This first minimum value R_{C,min} of the radius of curvature is, preferably, higher than or equal to 20 mm.

So as to reduce even more the part of the non-guided lightwave 4 that is recoupled in the exit fibre 20 with the guided lightwave, it can be provided, in a third embodiment shown in FIG. 6, that the optical waveguide 120 has, in addition to the first curved guide portion 124, at least one second curved guide portion 125 between the two modulation electrodes 131, 132 and the guide exit end 122.

In the case of the example shown in FIG. 6, the two curved guide portions 124, 125 are herein identical and S-shaped. Moreover, their radius of curvature R_{C} (shown in FIG. 6 only for the first curved portion 124) is identical to the radius of curvature of the first curved guide portion in the example given for the first embodiment (see FIG. 5).

Of course, in variants, it is possible to use one or several other curved guide portions in the electro-optic phase modulator in addition to the first curved guide portion.

That way, for a fixed value of the spatial offset H, it is possible to use curved guide portions 124, 125 having lower curvatures and introducing less losses in the modulator 100.

Likewise, for a fixed value of the radius of curvature R_{C}, it is then obtained a more important spatial offset H.

So as to reduce even more the residual amplitude modulation, the modulator 100 may comprise means for the electric polarization of the electro-optic substrate 110 to generate, in the latter, a permanent electric field that reduces the optical refractive index nₛ of the substrate 110 in the vicinity of the waveguide 120.

Generally, these electric polarization means comprise electrodes and electric control means to apply, between these electrodes, an electric voltage.

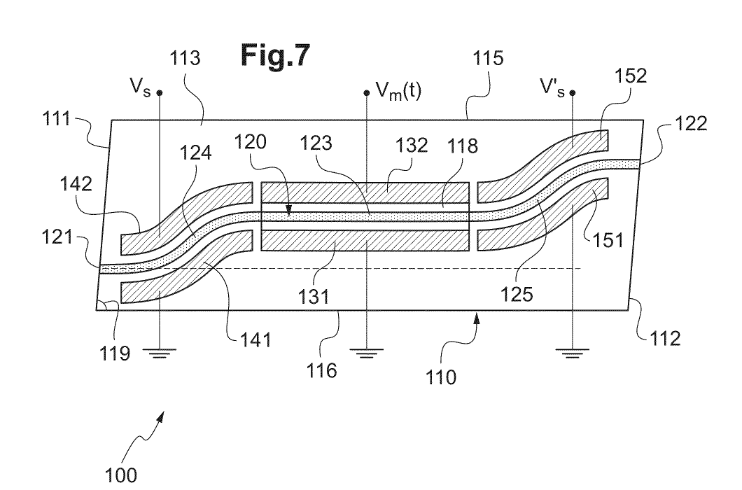

Therefore, in a third embodiment of the electro-optic phase modulator 100 shown in FIG. 7, the means for the electric polarization of the electro-optic phase modulator 100 herein comprise:
a first pair of polarization electrodes 141, 142, distinct and separated from the modulation electrodes 131, 132, the polarization electrodes 141, 142 being arranged parallel to the waveguide 120, herein between the guide entrance end 121 and the modulation electrodes 131, 132, and
a second pair of polarization electrodes 151, 152, distinct and separated from the modulation electrodes 131, 132, the polarization electrodes 151, 152 being arranged parallel to the waveguide 120 between the guide exit end 122 and the modulation electrodes 131, 132.

As well shown in FIG. 7, the polarization electrodes 141, 142, 151, 152 are, in this case, also curved so as to follow the curvature of the optical waveguide 120 in its curved guide portions 124, 125.

The first pair of polarization electrodes 141, 142 is intended to be polarized by a first polarization voltage Vₛ applied between the modulation electrodes 141, 142, thanks to additional electric control means, to generate a permanent electric field that reduces the optical refractive index n_{g} of the substrate 110 in the vicinity of the waveguide 120, herein in a region of the substrate 110 located under these additional polarization electrodes 141, 142.

Likewise, the second pair of polarization electrodes 151, 152 is intended to be polarized by a second polarization voltage V′ₛ applied between the polarization electrodes 151, 152 thanks to the additional electric control means, to generate another permanent electric field in the electro-optic substrate 110, herein under the two other additional polarization electrodes 151, 152, to reduce the optical refractive index nₛ of said substrate 110 in the vicinity of the waveguide 120.

Preferably, the polarization voltages Vₛ, V′ₛ are constant over time so that the permanent electric fields generated in the vicinity of the waveguide 120 by Pockels effect are also constant.

Thanks to these permanent electric fields that reduce the optical refractive index nₛ of the substrate 110 in the vicinity of the waveguide 120, the guided lightwave 4 of the waveguide 120 is deviated towards the lower face 114 of the substrate 110 so that the trajectory thereof deviate from the waveguide 120.

That way, the non-guided lightwave 4 that is deviated does no longer overlap with the guided lightwave 3 at the guide exit end 122, so that they cannot interfere between each other and lead to a residual amplitude modulation on the emerging lightwave 2 at the exit of the modulator 100.

In an alternative embodiment, only one pair of polarization electrodes could be used. Then, in this case, the single pair of additional polarization electrodes 141, 142 is preferably placed near the guide entrance end 121, so that the non-guided lightwave 4 is deviated from the beginning of its propagation in the substrate 110.

The permanent electric fields generated by the electric polarization means are such that the difference of optical refractive index induced in the electro-optic substrate 110 is preferably comprised in a range from 10⁻⁵ to 10⁻⁶.

Thanks to the electric polarization means, the modulator 100 may implement a modulation method comprising a step of polarization of these electric polarization means.

During this polarization step, the permanent electric field is generated, herein by application of the additional polarization voltage Vₛ, so as to reduce the optical refractive index nₛ of the electro-optic substrate 110 in the vicinity of the waveguide 120.

Tests have shown that, with two identical pairs of additional polarization electrodes 141, 142, 151, 152, each polarization electrode 141, 151 being spaced apart by 10 micrometres from the other polarization electrode of the same pair, each pair of polarization electrodes 141, 142, 151, 152 being polarized with a polarization voltage equal to 2.5 volts, it was possible to reduce the residual amplitude modulation by 10 dB or more.

As a variant, the electric polarization means may comprise the modulation electrodes and the associated electric control means.

When an additional polarization voltage Vₛ is applied between the modulation electrodes in addition to the modulation voltage Vₘ(t), so that the total voltage applied is equal to Vₘ(t)+Vₛ, a permanent electric field is generated in a region of polarization of the substrate located in the vicinity of the waveguide, near and under the modulation electrodes.

Preferably, this additional polarization voltage Vₛ is constant over time so that the permanent electric field generated in the region of polarization is also constant.

In order to deviate the non-guided lightwave away from the waveguide, the additional polarization voltage Vₛ is adjusted so that the permanent electric field in the substrate decreases, by Pockels effect, the optical refractive index nₛ of the electro-optic substrate in the vicinity of the waveguide in the region of polarization.

The non-guided lightwave is then deviated so that its trajectory deviates from the region of polarization of lower index than the remaining of the substrate.

That way, the non-guided lightwave does not overlap either with the guided lightwave at the guide exit end, with the result that they can no longer interfere between each other and lead to a residual amplitude modulation in the emerging lightwave at the exit of the modulator.

With modulation electrodes of 40 millimetre long, spaced apart by 10 micrometres, between which a polarization voltage of 5 to 10 volts is applied, the residual amplitude modulation is reduced by 10 decibels or more.

In practice, the total voltage Vₘ(t)+Vₛ is applied on said modulation electrodes so as to simultaneously modulate the lightwave guided in the waveguide and deviate the non-guided lightwave towards the lower face of the substrate.

Preferably, the amplitude of the additional polarization voltage Vₛ is adjusted, so that the sign, positive or negative, of the total voltage Vₘ(t)+Vₛ applied on the modulation electrodes is constant.

For example, when the modulation voltage Vₘ(t) is a periodic square pulse modulation, taking alternately positive and negative values, for example +1 V and −1 V, an additional polarization voltage Vₛ can be chosen constant and equal to −5V, so that the total voltage Vₘ(t)+Vₛ applied is always negative.

The additional polarization voltage Vₛ being constant, it is associated with an additional optical phase advance or delay of the lightwave guided in the waveguide, advance or delay that is hence constant as a function of time. Hence, the application of this additional polarization voltage Vₛ on the modulation electrodes does not disturb the modulation of the optical phase of the guided lightwave.

1. An electro-optic phase modulator (100), intended to modulate the optical phase of a lightwave (1) incident on said modulator (100), including:
an optically transparent electro-optic substrate (110), comprising an entrance face (111), an exit face (112), two lateral faces (115, 116), a lower face (114) and an upper face (113), said lower (114) and upper (113) faces extending between the entrance face (111) and the exit face (112), said upper face (113) being planar and opposite to said lower face (114),
an optical waveguide (120) that extends, in a plane parallel to said upper face (113), between a guide entrance end (121) located on said entrance face (111) of the substrate (110) and a guide exit end (122) located on said exit face (112) of the substrate (110), said incident lightwave (1) being partially coupled in said optical waveguide (120) into a guided lightwave (3) propagating in an optically guided manner along the optical path of said optical waveguide (120) between said guide entrance end (121) and exit end (122), and
at least two electrodes (131, 132, 133) that are arranged at least partially along said waveguide (120), parallel to and on either side of the latter, and that define between each other an inter-electrode gap (118), said electrodes (131, 132, 133) allowing to introduce, when a modulation voltage (Vₘ) is applied between them, a modulation phase-shift, function of said modulation voltage (Vₘ), on said guided lightwave (3) propagating in said optical waveguide (120),
characterized in that said optical waveguide (120) has at least one first curved guide portion (124) between said entrance end (121) and said at least two electrodes (131, 132), so that the extension of a direction (121T) tangent to said waveguide (120) on said entrance face (111) deviate from said inter-electrode gap (118).

2. The phase modulator according to claim 1, wherein the gap H introduced by the first curved guide portion (124) corresponding to the distance between said tangent direction (121T) and an inner edge (131A) of a first electrode (131) located between said optical waveguide (120) and said tangent direction (121T), this distance being measured in a front plane (Pₐ) perpendicular to said tangent (121T) comprising a front edge (131C) of said first electrode (131), this gap H being higher than a predetermined threshold value Hₘᵢₙ.

3. The phase modulator (100) according to claim 2, wherein the threshold value Hₘᵢₙ is predetermined so that, said incident lightwave (1) being partially coupled in said substrate (110) into a lightwave that propagates in a non-optically guided manner in said substrate (110) and that has, in said front plane (Pₐ), a spatial extension w, the predetermined threshold value Hₘᵢₙ is higher than or equal to w/2.

4. The phase modulator (100) according to claim 2, wherein the threshold value Hₘᵢₙ is predetermined so that, said incident lightwave (1) being partially coupled in said substrate (110) into a lightwave that propagates in a non-optically guided manner in said substrate (110) and that has, in said front plane (Pₐ), a spatial extension w and said inter-electrode gap (118) having a width (E), the predetermined threshold value Hₘᵢₙ is equal to w/2+E.

5. The electro-optic phase modulator (100) according to claim 1, wherein said optical waveguide (120) has at least one second curved guide portion (125) between said at least two electrodes (131, 132) and said guide exit end (122).

6. The electro-optic phase modulator (100) according to claim 1, wherein the first curved guide portion (124) has a S-shape.

7. The electro-optic phase modulator (100) according to claim 5, wherein the first curved guide portion (124) and/or the second curved guide portion (125) has a S-shape.

8. The electro-optic phase modulator (100) according to claim 1, wherein the first curved guide portion (124) has a radius of curvature R_{C} whose value is higher than a predetermined minimum value R_{C,min} so that the optical losses induced by each curved guide portion (124, 125) are lower than 0.5 dB.

9. The electro-optic phase modulator (100) according to claim 5, wherein the first curved guide portion (124) and/or the second curved guide portion (125) has a radius of curvature R_{C} whose value is higher than a predetermined minimum value R_{C,min} so that the optical losses induced by each curved guide portion (124, 125) are lower than 0.5 dB.

10. The electro-optic phase modulator (100) according to claim 8, wherein said minimum value R_{C,min} of the radius of curvature R_{C} of the first curved guide portion (124) is higher than or equal to 20 mm.

11. The electro-optic phase modulator (100) according to claim 9, wherein said minimum value R_{C,min} of the radius of curvature R_{C} of each curved guide portion (124, 125) is higher than or equal to 20 mm.

12. The electro-optic phase modulator (100) according to claim 1, including a third modulation electrode (133) formed on said upper face (113) of the substrate (110), above said optical waveguide (120), and having a width higher than that of said optical waveguide (120).

13. The electro-optic phase modulator (100) according to claim 1, including at least one pair of polarization electrodes (141, 142) arranged parallel to said optical waveguide (120), between said guide entrance end (121) and said modulation electrodes (131, 132).

14. The electro-optic phase modulator (100) according to claim 1, including another pair of polarization electrodes (151, 152) arranged parallel to said optical waveguide (120), between said modulation electrodes (131, 132) and said exit end (122).

15. The electro-optic phase modulator (100) according to claim 13, including another pair of polarization electrodes (151, 152) arranged parallel to said optical waveguide (120), between said modulation electrodes (131, 132) and said exit end (122).

16. The electro-optic phase modulator (100) according to claim 1, wherein said substrate (110) is a non-straight parallelepiped, such that said entrance face (111) and one of the lateral faces (116) form an angle (119) lower than 90°.
